(19) United States
(12) Patent Application Publication
(10) Pub. No.: US 2002/0060692 A1
(43) Pub. Date: May 23, 2002

(54) Method for increasing multimedia data accessibility

(75) Inventor: Raymond M. Broemmelsiek, San Diego, CA (US)

Correspondence Address: Breiner & Breiner, L.L.C., P.O. Box 19290, Alexandria, VA, 22320-0290, US

(73) Assignee: Pixel Kinetix, Inc., San Diego, CA

(21) Appl. No.: 10/052,539

(22) Filed: Jan. 23, 2002

Related U.S. Application Data
(62) Division of application No. 09/441,231, filed on Nov. 16, 1999.

(51) Int. Cl. G09G 5/00

(52) U.S. Cl. 345/649

(57) ABSTRACT

A method for increasing multimedia data accessibility is presented and more specifically increasing the interactivity with images shown on a display device. A series of images is displayed according to a user's position relative to a display screen by displaying a first image, receiving information regarding a change in the user's position relative to the display screen, and displaying a second image in response to the change in the user's position. The series of images are packaged, compressed and transmitted in a manner that makes it feasible to simultaneously receive, display and interact with the series of images. The scale of a portion of the images is manipulated based on interaction therewith.

### FIELD OF THE INVENTION

The present invention relates to a method for increasing multimedia data accessibility and more specifically to increasing the interactivity with images shown on a display device.

### BACKGROUND OF THE INVENTION

While there are a number of computer-based media types that provide interactive 3D representations of objects or scenes, none of these media types provides intuitive interaction while being inexpensively produced and lending themselves to Internet content delivery and play back. The Internet's range of media types is driven largely by transmission bandwidth limitations together with the need for new and more compelling content that make use of new media types.

Further, the method by which these media types are viewed and interacted with restricts the users to able-bodied people. When viewing an image, visually impaired people can only view the image when using magnification software supplied by a third party. The available magnification software is cumbersome to use when trying to take advantage of multimedia data, especially images. Often it is desired to magnify only the image; however, third party software does not readily offer this feature. There are two basic types of magnification software: entire display magnification which hides from immediate view a large portion of the screen, and mouse centered magnification which provides a fixed screen showing an enlarged version of the area around the mouse. These systems provide only a partial solution as the available magnification software does not provide quick access to the program nor is it flexible enough to use alternative input devices.

The interactive 3D media types available that are compatible with Internet resource limitations (i.e. QuicktimeVR by Apple Corp. and 360 by IPIX Corp.) require labour intensive production or special capture equipment. This increases the cost of producing these interactive 3D media types. Further, user navigation of these 3D media types uses a mouse, which is not an intuitive navigation tool, especially when viewing images of a scene. Additionally, these media types require media transmission to be completed before viewing or interacting with the media. In cases where the size of the media is large, this creates a long time delay before the images can be viewed.

Existing immersive virtual reality technologies provide for 3D interactivity but require special head gear or viewing apparatus, or special cameras. In addition, these methods do not provide for low bandwidth transmission and low latency response to user input.

U.S. Pat. No. 5,574,836, titled “Interactive Display Apparatus and method with Viewer Position Compensation”, discloses a system that provides an intuitive interactive environment for users. However, this system is based on changing the position of an object to be displayed according to the position of the user. As this system is concerned with changing the position of an object, it does not provide a method for intuitive interaction in a 3D environment or viewing a 3D object from a plurality of viewing angles

### SUMMARY OF INVENTION

Accordingly, it is an object of the invention to provide a method for intuitively viewing an image or series of images (either multiple views of an object or different images of unrelated objects).

It is a further object of the invention to provide a method which provides intuitive navigation within a 3D environment.

It is another object of the invention to provide a method which provides intuitive navigation of a 3D image without requiring the position of the viewed object to change.

It is an additional object of the invention to provide a method for transmitting and viewing a series of related images that conforms to Internet resource limitations.

It is a further object of the invention to provide a method for viewing and interacting with images from a series of images prior to receiving every image.

It is a further object of the invention to provide an easily accessible, integrated screen display magnification tool.

In accordance one object of the present invention there is provided a method of displaying a series of images according to a user's position relative to a display screen comprising the steps of: displaying a first image from the series of images, receiving information regarding a change in the user's position relative to the display screen, and displaying a second image from the series of images in response to the change in the user's position.

In accordance with another object of the invention there is provided a method of simultaneously receiving, displaying and interacting with a series of images in response to movement of an interactive device comprising the steps of: (a) receiving for display a first image from the series of images, (b) receiving for display subsequent images from the series of images, and (c) permitting viewing of and interacting with the first image while performing step (b) where interaction with the first image is in response to signals from the interactive device.

In accordance with a further object of the invention there is provided a method of transmitting a series of images to increase the fidelity of transmission comprising the steps of: compressing a selected first image from the series of images separately compressing each image from the series of images, and progressively transmitting each compressed image from the series of images in a manner that first transmits the selected first compressed image and then transmits each image from the series of images such that the further each image is from the selected first compressed image the later it is transmitted.

In accordance with another object of the invention there is provided a method of increasing the scale of a portion of a displayed object comprising the steps of: providing a perpetual foreground icon for accessing a magnification tool, accessing the magnification tool, tracking movement of an interactive device, displaying a specified area as an enlarged area, and changing an enlargement power in response to the interactive device while tracking movement and displaying the specified area.

In accordance with yet another object of the invention there is provided a computer readable medium having stored thereon computer-executable instructions for displaying a series of images according to a user's position relative to a display screen comprising the steps of: displaying a first image from the series of images, receiving information regarding a change in the users position relative to the display screen, and displaying a second image from the series of images in response to the change in the user's position.

In accordance with a further object of the present invention there is provided a computer readable medium having stored thereon computer-executable instructions for simultaneously receiving, displaying and interacting with a series of images in response to movement of an interactive device comprising the steps of: (a) receiving for display a first image from the series of images, (b) receiving for display subsequent images from the series of images, and (c) permitting viewing of and interacting with the first image while performing step (b) where interaction with the first image is in response to signals from the interactive device.

In accordance with another object of the invention there is provided a computer readable medium having stored thereon computer-executable instructions for transmitting a series of images to increase the fidelity of transmission comprising the steps of: compressing a selected first image from the series of images, separately compressing each image from the series of images, and progressively transmitting each compressed image from the series of images in a manner that first transmits the selected first compressed image and then transmits each image from the series of images such that the further each image is from the selected first compressed image the later it is transmitted.

In accordance with another object of the present invention there is provided a computer readable medium having stored thereon computer-executable instructions for increasing the scale of a portion of a displayed object comprising the steps of: providing a perpetual foreground icon for accessing a magnification tool, accessing the magnification tool, tracking movement of an interactive device, displaying a specified area as an enlarged area, and changing an enlargement power in response to the interactive device while tracking movement and displaying the specified area.

### BRIEF DESCRIPTION OF THE DRAWINGS

The present invention will be described in greater detail below, including specific examples thereof, with regard to the figures, in which:

FIG. 1A is an illustration of a prior art system used to capture images at various view angles to comprise the image set used during playback,

FIG. 1B is an illustration of an embodiment of the present invention in which the capture system of FIG. 1A is shown in connection with various display computers,

FIG. 2 is a prior art illustration of resulting images from the corresponding image capture view angles.

FIG. 3 is an illustration of a recording system used for automated image capture according to an embodiment of the present invention,

FIG. 4 is an illustration of compression and transmission sequence used during transmission of images according to an embodiment of the present invention,

FIG. 5 is an illustration of a computer system that is used to play back the images according to an embodiment of the present invention,

FIG. 6 is a top view illustration of the various head angles that result in display of corresponding images from FIG. 2 according to an embodiment of the present invention, and

FIG. 7 is a screen view of a screen magnification tool.

### DETAILED DESCRIPTION OF INVENTION

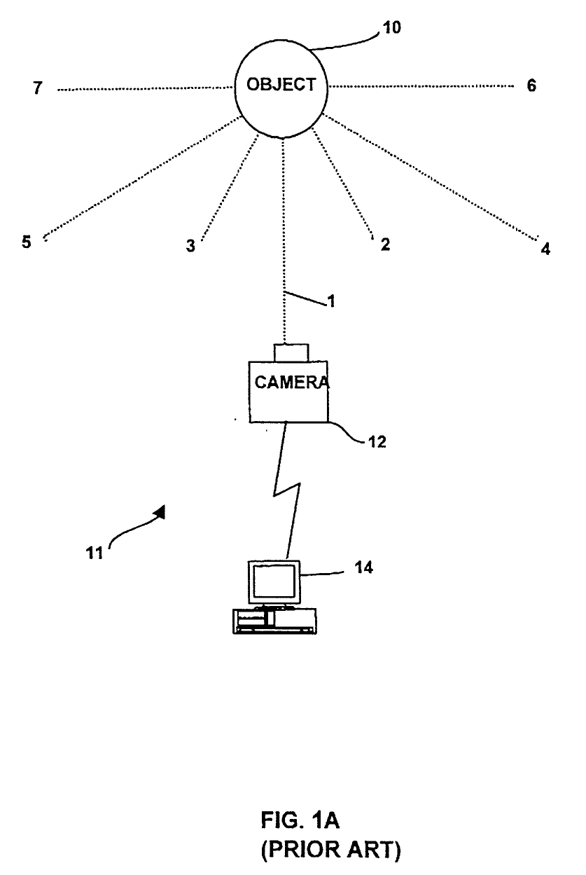

FIG. 1A is an image capture system 11 according to the prior art wherein 2-Dimensional images are used to create a simulated, interactive 3-Dimensional environment. The image capture system 11 includes a camera 12 and an object 10 showing various image capture rotation angles 1, 2, 3, 4, 5, 6, 7 that comprise an image set used during playback and a computer 14 used for image formatting. Individual capture rotation angles are shown: a reference angle 1, rightward rotation angles 3, 5, and 7 and leftward rotation angles 2, 4, and 6.

A system 13 according to an embodiment of the present invention shown in FIG. 1B is composed of three segments: image capture 11, image transmission, and image display. The computer 14 functions for packaging the series of images from the image capture system 11 for efficient image transmission. Transmission links 16 to the computer 14 provide electrical communication to other computers 18 that are equipped for image display.

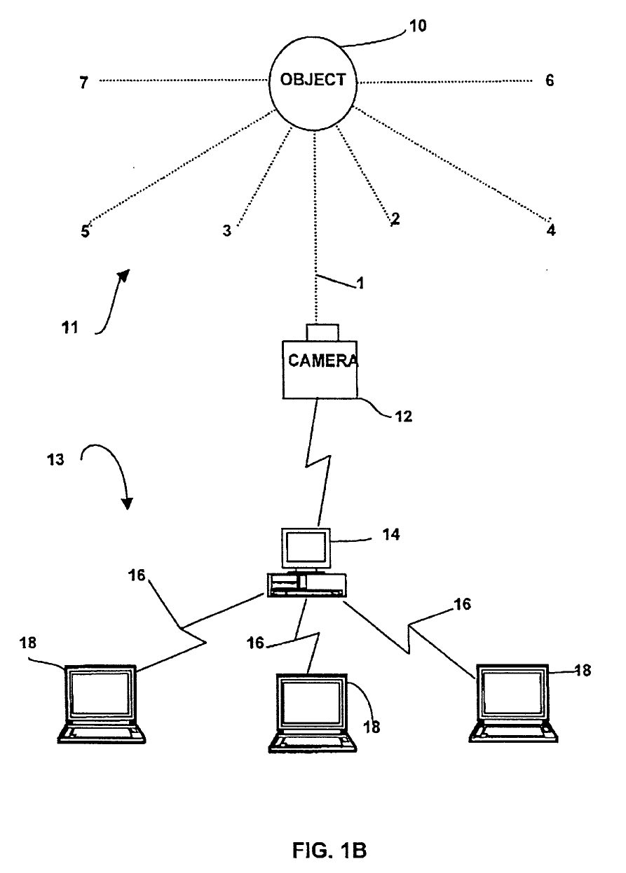

FIG. 2 is a sample illustration of resulting individual images 20 from the corresponding image capture rotation angles 1, 2, 3, 4, 5, 6, and 7 shown in the image capture system 11 of FIG. 1A. A reference image 21 corresponds to the reference angle 1 shown in FIG. 1A. Leftward rotation images 23, 25, and 27 correspond to leftward rotation angles 3, 5, and 7 respectively. Similarly, rightward rotation images 22, 24, and 26 correspond to rightward rotation angles 2, 4, and 6 respectively. Although only left and right rotation image capture sequences are shown, this method may be extended to account for camera/object rotation angles that displace in the up and down axes as well, generating a mosaic of images.

The camera 12 shown in FIGS. 1A and 1B can be moved about the object 10 or the object 10 can be rotated before the camera 12 generating various views 1 to 7 and thus, the corresponding images 20 are captured. The captured images 20 are stored in computer 14.

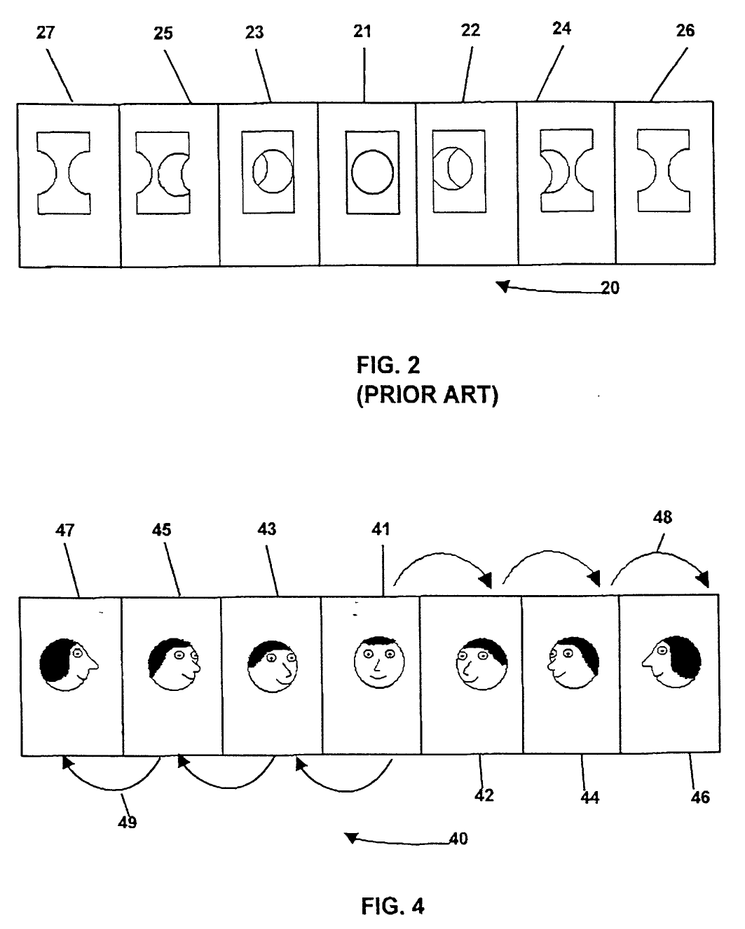

The image series can also be a dynamic series in which movement occurs. The camera 12/object 10 spatial relationship may be changed manually or by machine control. FIG. 3 is an illustration of a recording system 37 used for automated image capture. A camera 33 is mounted to a servo-controlled pan and tilt gimble 34. The servo-controlled pan and tilt gimble 34 is controlled by a computer 36 through an electrical communication media 35 using motion object tracking algorithms which are known in the art. By processing a video signal from the camera 33 delivered to the computer 36 through the electrical communication media 35, the computer 36-controls the servo-controlled pan and tilt gimble 34 again through the electrical communication 35 such that the camera 33 maintains line-of-sight 31 with a moving object 30 having a trajectory 32. In this manner, a sequence of images is captured such as those shown in FIG. 2.

There are several methods available as well that use conventional video cameras, or digital still cameras. For example, a hand-held video camera may be pointed at the subject or scene that is to be captured and processed into a 3D computer image. Once recorded, the images may be edited on a computer as required and then formatted for “playback” by the holographic image user. These images can be edited in the computer 14 (of FIG. 1B) to form a continuous series of images that represent a complete field of view.

Image Transmission

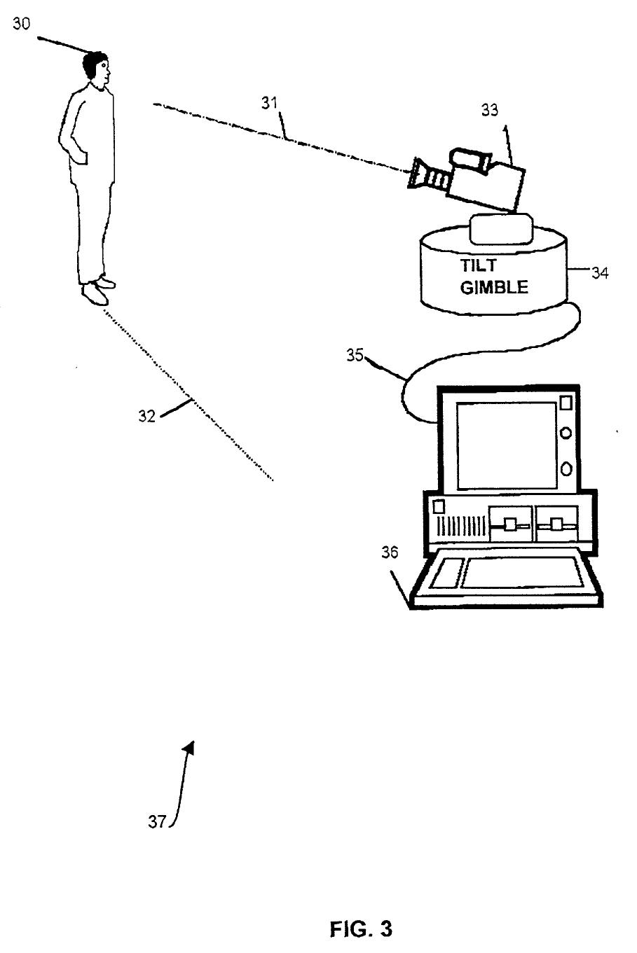

A series of images (i.e. as shown in FIGS. 2 and 4) is first compressed and then each image is transmitted according to its positional relationship with a reference image (i.e. image 21 in FIG. 2 and image 41 in FIG. 4). According to an embodiment of the present invention, the computer 14 connected to the capture camera 12 may be used for packing the series of images for efficient transmission. As shown in FIG. 1B, the transmission links 16 may optionally provide electrical communication to other computers 18 that are equipped for image display.

As shown in FIG. 4, a sequence of images 40 is captured either manually or automatically. After editing, the images 40 are formatted and compressed. The preferred method of compression is carried out such that one image is first selected for compression—typically the reference image 41 in the sequence of images 40. Because of the strong content correlation between the reference image 41 and outlying rotation image 48 and 49, motion video compression algorithms as are known in the art can be employed on the outlying rotation images 48 and 49 to reduce the data size for improved transmission efficiency. Therefore, a motion compression algorithm is applied separately on outlying leftward rotation image 49 and outlying rightward rotation image 48 of sequence 40 lying on either sided of the reference image 41 where the reference image is the first image to be displayed as data is received for presentation.

A greater amount of data must be transmitted to an image display (i.e. the computers 18 as shown in FIG. 1B) for a 3D presentation of a sequence of images 40 than that of a single image as the 3D presentation uses several views of an object. Increased data transmission potentially delays the point in time at which the user may view the holographic or 3D nature of the image data. In order to overcome this, formatting and compression are done such that a progressive approach is used in which a portion of the data may be viewed and interacted with before the entire set of data is received. In order to reduce delay, to provide the user with useful but not necessarily complete information sooner, the following order is used:

1) Given that the uncompressed and unformatted representation (raw data) of the holographic image of an object is a series of images 40 of that object, each successive image is captured at a subsequently larger view angle than the first capture image. For purposes of applying known interframe motion compression techniques and for initial viewing of the holographic object image, the reference image 41 (or center image) becomes the reference for the outlying images. This is the first image transmitted.

2) Given that the sequence of images 48 and 49 lying on either side of the reference image 41 exhibit very strong frame-to-frame correlation, interframe motion compression is applied separately to each of the outlying leftward rotation image 49 and outlying rightward image 48 to achieve superior compression ratios.

3) The resulting compressed images from the outlying rightward rotation images 48 and the outlying leftward rotation images 49 are transmitted progressively in an order that allows compressed images further away from the reference image 41 to be transmitted later. Therefore, the compressed images are ordered alternating left and right side of the reference image 41 as follows: image 43, image 42, image 45, image 44, image 47, and image 46.

The further away an image is from the reference image 41, the later it is transmitted. In this manner, early presentation of an object image is viewable during the presentation phase while media data is still being transmitted; therefore, 3D image fidelity increases over time. In general, data that increases pixel or spatial resolution is transmitted progressively later.

Image Display

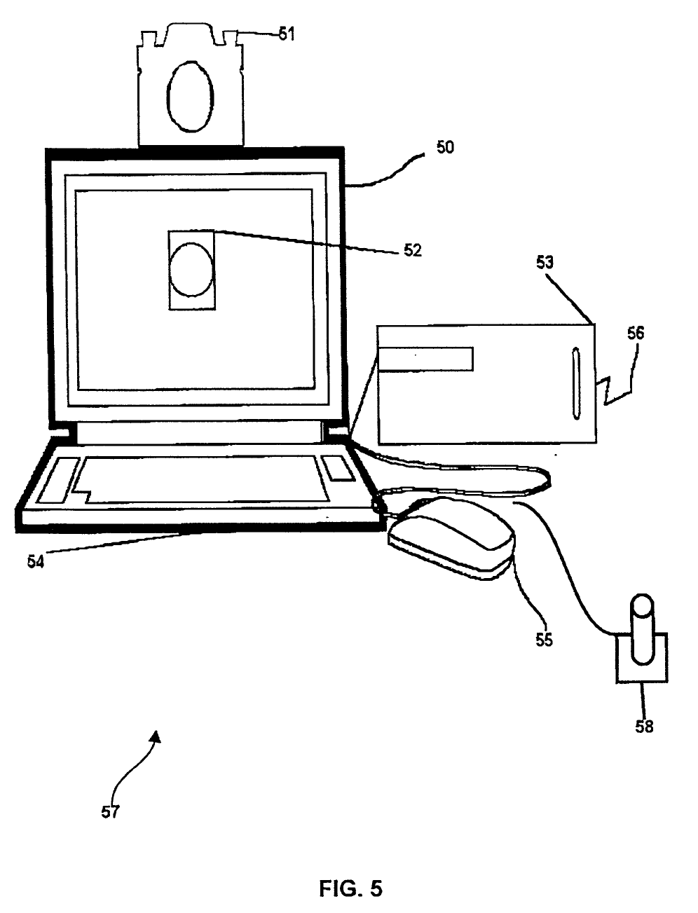

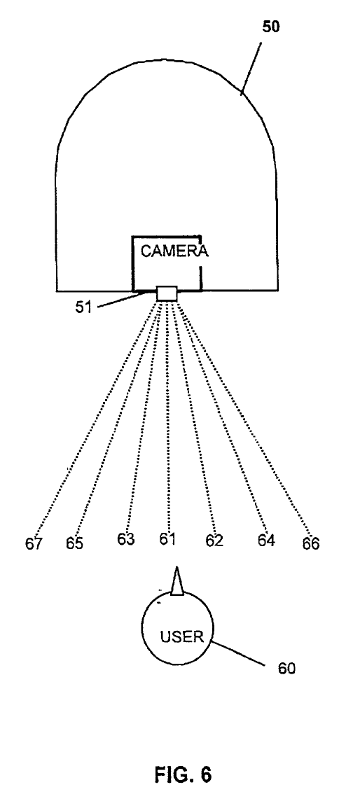

After the media is captured, edited, formatted, compressed, and transmitted, an image series display method of the system of the present invention is applied. Referring now to an embodiment in FIG. 5, which is an illustration of a computer system 57 that is used to play back the images. The computer system 57 includes a computer display 50, a computer camera 51, a keyboard 54 and a mouse 55 (or other pointing device), a joystick 58, and a computer 53 that are electrically connected to each other using standard and known interconnection protocols. As shown in FIG. 6, the computer camera 51 is mounted on or near the computer display 50 such that the user's head 60 is within the field of view of the computer camera 51 while a user's head 60 is positioned to have the computer display 50 within convenient viewing range.

The computer camera 51 is connected to and operated by the computer 53 such that the video signal from the camera 51 is received by the computer 53 for processing. The computer 53 processes the video signal to implement real-time head tracking such that the user's head 60 is actively tracked to determine it's relative spatial relationship to the computer display 50. A method of head tracking is discussed in detail in Applicant's U.S. Pat. No. 5,574,836 titled “Interactive Display Apparatus and Method with Viewer Position Compensation” herein incorporated by reference.

Optionally, if the images to be presented are received from a remote location as in the case of a web server (not shown), then a transmission link 56 (such as a modem, Digital Subscriber Line (DSL), cable connection) is connected to the computer 53 such that the compressed and formatted images may be received for presentation.

Next, the presentation method according to an embodiment of the present invention will be detailed. A formatted and compressed image sequence 20 such as those shown in FIG. 2 is received via transmission link 56 and now resident in part or in entirety on the computer 53. The first image to be received is the reference image 21 as shown in FIG. 2. The reference image 21 may be the only image transmitted or it may be the first image of a series of images. If there are no other images available for display, then this image will be selected for display in a view window 52 (see FIG. 5). If only the reference image 21 is sent then the with the image sequence 20 is initiated. The view window 52 is that area of the computer display 50 in which one of the images in the image sequence 20 is being displayed.

There are several degrees of movement under which the user's head 60 can be followed. Relative to the computer display 50, these include translation from left to right, translation in and out, head roll from left to right, and head tilt up and down. For the purpose of illustration, translation from left to right is now presented. This is not intended to represent the preferred degree of freedom as all degrees contribute to the modeling of a 3D physical representation.

As the user's head 60 moves from side to side changing rotation angles 61 through 67 as denoted in FIG. 6, a corresponding image relating to the current rotation angle is shown in the view window 52. Assuming now that the user's head 60 is at rotation angle 61, the reference image 21 is shown in view window 52. Accordingly, when the user's head 60 position is moved to rotation angle 63, image 23 is displayed. Likewise, for rotation angle 65 results in image 25 displayed, rotation angle 67 results in image 27 displayed, rotation angle 62 results in image 22 displayed, rotation angle 63 results in image 24 displayed, and rotation angle 64 results in image 26 displayed. The actual number of images and the rotation angles used in this example are not intended to be limiting as these values may vary as required for a specific implementation.

In the event that image data transmission is in progress while image data is displayed, then the method presented here will allow interaction with the image sequence 20 prior to receiving individual images. If the preferred image for display is not available then a substitute will be provided until that image is available. For example, if the users head 60 is now at rotation angle 67 but the corresponding image 27 is not yet transmitted, then the nearest neighbor image will be displayed in the display window 52 in the following order of preference, image 25, image 23, and image 21. Accordingly, this method applies to right side rotation angle images 22, 24, and 26. This method may be extended to other degrees of freedom and view angles as is reflected in a physical modeling of the capture process.

Although the aforementioned embodiment uses head motion to interact with the images, this is not the only possible method of interaction; other body parts may also be tracked to navigate through an image series. Alternatively, more traditional devices such as the mouse 55 or the joystick 58 may be used (see FIG. 5).

Additional attributes that depart from real world simulated viewing are also added to aid in viewing. Examples of these are continuous object rotation, and amplified scaling of an image.

For the case in which only a single image is available for presentation, the distance between the user's head 60 and computer's display 50 as determined by the head tracking software is used to scale the image size. Other head movements such as tilt, roll, and displacement which are normally used to simulate change in view angles are not used in their normal function. These head movements are used to change the position of the image being viewed.

Screen Magnification

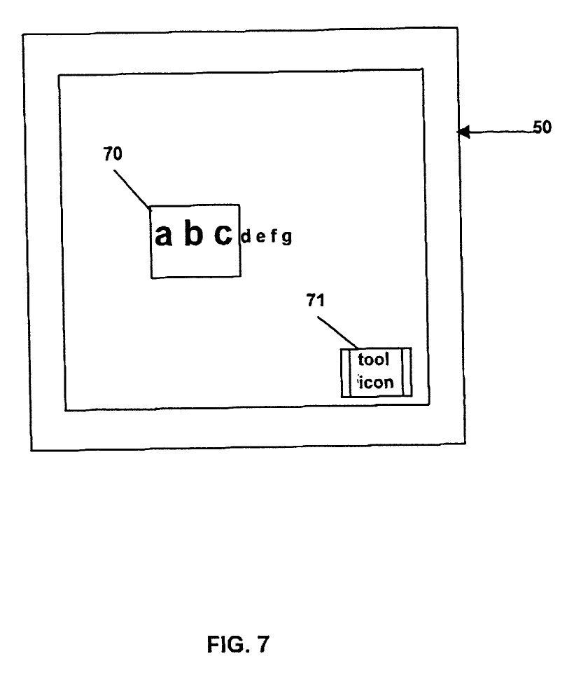

FIG. 7 shows a computer display 50 wherein a screen magnification tool 70 is provided according to an embodiment of the present invention. The screen magnification tool 70 can be quickly accessed through highlighting of an icon 71 on the screen which remains in the foreground of the display 50. Accessing the magnification tool 70 is made simpler by requiring only a single highlight of the icon in distinction from the double “mouse click” that has become the industry standard for executing a program.

To allow for more intuitive interaction with the magnification tool 70, magnification power can be revised in the same manner as the tool 70 is used. For example, magnification power of the tool 70 can be increased or decreased through the use of a scroll wheel on a standard mouse. Alternatively, head tracking (as disclosed above) may be used to move the position of magnification tool 70 and also change the magnification power through an action such as forward and backward translation, for example.

In this manner, the magnification tool 70 acts identically to a physical magnification glass. As a result, users will find interaction with the magnification tool 70 simplified as they may interact with the tool 70 just as they would the well-known physical device.

Media presentation consists of receiving the image data, decompressing it, loading it into memory and displaying one of the images that compose media, the selection of that image which is made by the user's head position with respect to the display device. The selection process is done in such a way that the user's view angle with respect to the display is represented by the camera's view angle with respect to the object. This selection process results in enhancing the user's perception of a 3D interactive environment or of viewing a 3D object as opposed to a 2D image of a 3D object.

For example, as the user moves his head to the left, a image showing more of left side of the object image is shown. If the user looks over the top or up, a image representing the angle of the object is shown (provided multiple left-to-right image sequences are captured at media generation time). If the user moves closer to the display, the image is scaled up representing a closer look of the 3D object. If images providing additional resolution are transmitted, then these are presented rather than scaling the image.

1. A method of displaying a series of images according to a user's position relative to a display screen, said display method comprising:
displaying a first image from the series of images;
receiving information regarding a change in the user's position relative to the display screen; and
displaying a second image from the series of images in response to the change in the users position.

2. The method of displaying according to claim 1 wherein the series of images is a series of 2-dimensional images.

3. The method of displaying according to claim 1 wherein the change in the user's position is determined by a change in the user's head position.

4. The method of displaying according to claim 3 wherein the second image is an image from the series of images determined by the user's head position where the change in the user's head position is a result of movement selected from the group consisting of left head roll, right head roll, up tilt, down tilt, right translation, left translation, forward translation and backward translation.

5. The method of displaying according to claim 4 wherein the right translation and left translation produce a continuous rotation of images in the series of images.

6. The method of displaying according to claim 3 wherein the second image is the first image displayed with new display characteristics.

7. The method of displaying according to claim 6 wherein the new display characteristic for the first image is selected from the group consisting of right translation, left translation, increase in scale and decrease in scale in response to the user's head position where the change in the user's head position is a result of movement selected from the group consisting of right translation, left translation, forward translation and backward translation.

8. The method of displaying according to claim 1 wherein the first image is a center image of the series of images.

9. The method of displaying according to claim 1 wherein if the second image is not available to be displayed then an available image in the series of images closest to the second image is displayed.

10. A method of simultaneously receiving, displaying and interacting with a series of images in response to movement of an interactive device, said display method comprising:
(a) receiving for display a first image from the series of images;
(b) receiving for display subsequent images from the series of images; and
(c) permitting viewing of and interacting with the first image while performing step (b) where interaction with the first image is in response to signals from the interactive device.

11. The method according to claim 10 wherein the series of images is a series of 2-dimensional images.

12. The method according to claim 10 wherein the signals from the interactive device represent movement of the interactive device.

13. The method according to claim 12 further including the step of displaying a second image in response to movement of the interactive device.

14. The method according to claim 13 wherein the second image is an image from the series of images determined by the movement of the interactive device where the movement is selected from the group consisting of left movement, right movement, forward movement and backward movement.

15. The method according to claim 11 wherein the right movement and left movement produce a continuous rotation of images in the series of images.

16. The method according to claim 10 wherein the interactive device is that of a tracking ball.

17. The method according to claim 10 wherein the interactive device is that of a joystick.

18. The method according to claim 10 wherein the interactive device tracks body part movement.

19. The method according to claim 18 wherein the body part being tracked is the head.

20. The method according to claim 10 wherein the first image is a center image of the series of images.

21. The method according to claim 13 wherein if the second image is not available to be displayed then an available image in the series of images closest to the second image is displayed.

22. A method of transmitting a series of images to increase fidelity of transmission, said transmission method comprising:
compressing a selected first image from the series of images;
separately compressing each image from the series of images; and
progressively transmitting each compressed image from the series of images in a manner that first transmits the selected first compressed image and then transmits each image from the series of images such that the further each image is from the selected first compressed image the later it is transmitted.

23. The method of transmitting according to claim 22 wherein the series of images is a series of 2-dimensional images.

24. The method according to claim 22 wherein the selected first compressed image is a center image in the series of images.

25. A computer readable medium having stored thereon computer-executable instructions for displaying a series of images according to a user's position relative to a display screen comprising the steps of:
displaying a first image from the series of images;
receiving information regarding a change in the user's position relative to the display screen; and
displaying a second image from the series of images in response to the change in the user's position.

26. A computer readable medium having stored thereon computer-executable instructions for simultaneously receiving, displaying and interacting with a series of images in response to movement of an interactive device comprising the steps of:
(a) receiving for display a first image from the series of images;
(b) receiving for display subsequent images from the series of images; and
(c) permitting viewing of and interacting with the first image while performing step (b) where interaction with the first image is in response to signals from the interactive device.

27. A computer readable medium having stored thereon computer-executable instructions for transmitting a series of images to increase the fidelity of transmission comprising the steps of:
compressing a selected first image from the series of images;
separately compressing each image from the series of images; and
progressively transmitting each compressed image from the series of images in a manner that first transmits the selected first compressed image and then transmits each image from the series of images such that the further each image is from the selected first compressed image the later it is transmitted.

28. A method of increasing the scale of a portion of a displayed object, said method comprising:
providing a perpetual foreground icon for accessing a magnification tool;
accessing the magnification tool;
tracking movement of an interactive device;
displaying a specified area as an enlarged area; and
changing an enlargement power in response to the interactive device while tracking movement and displaying the specified area.

29. A computer readable medium having stored thereon computer-executable instructions for increasing the scale of a portion of a displayed object comprising the steps of:
providing a perpetual foreground icon for accessing a magnification tool;
accessing the magnification tool;
tracking movement of an interactive device;
displaying a specified area as an enlarged area; and
changing an enlargement power in response to the interactive device while tracking movement and displaying the specified area.
